(19) United States
(12) Patent Application Publication
(10) Pub. No.: US 2026/0365240 A1
(43) Pub. Date: Nov. 19, 2026

(54) SYSTEM AND METHOD FOR CONTROLLING WORK MACHINE

(71) Applicant: KOMATSU LTD., Tokyo (JP)

(72) Inventors: Shinichi OTAKA, Tokyo (JP); Takaomi KOMURA, Tokyo (JP); Ryoichi NAGASAKA, Tokyo (JP); Osamu YATSUDA, Tokyo (JP)

(21) Appl. No.: 19/121,880

(22) PCT Filed: Aug. 24, 2023
(86) PCT No.: PCT/JP2023/030544

§ 371 Date: Apr. 17, 2025

(30) Foreign Application Priority Data
Nov. 9, 2022 (JP) 2022-179433

(51) Int. Cl. B62D 11/18; B62D 6/04

(52) U.S. Cl. CPC B62D 11/183; B62D 6/04

(57) ABSTRACT

A work machine includes a vehicle body, left and right drive wheels, a drive source, and a drive device. A system to control the work vehicle includes a yaw angle sensor to detect an actual yaw angular velocity of the vehicle body, and a controller that controls the drive device to turn the vehicle body by a rotational speed difference between the left and right drive wheels. The controller calculates a theoretical yaw angular velocity of the vehicle body according to control of the drive device, acquires the actual yaw angular velocity, calculates an actual slip value indicating a magnitude of a slip of the vehicle body during turning based on the theoretical and actual yaw angular velocities, and controls a rotational speed of at least one of the left and right drive wheels such that the actual slip value reaches a predetermined target slip value higher than 0.

### CROSS-REFERENCE TO RELATED APPLICATIONS

This application is a U.S. National stage application of International Application No. PCT/JP2023/030544, filed on Aug. 24, 2023. This U.S. National stage application claims priority under 35 U.S.C. § 119 (a) to Japanese Patent Application No. 2022-179433, filed in Japan on Nov. 9, 2022, the entire contents of which are hereby incorporated herein by reference.

### BACKGROUND

### Technical Field

The present disclosure relates to a system and a method for controlling a work machine.

### Background Information

Some work machines turn a vehicle body, based on a speed difference between left and right drive wheels. For example, in a tracked vehicle according to JP2000-142455A, a clutch and a brake are coupled to each of left and right drive wheels. The tracked vehicle includes left and right crawler belts, and the crawler belts are driven by the rotation of the left and right drive wheels. When turning the vehicle, the operator operates the steering lever. The controller of the vehicle sets a turn command according to the operation of the steering lever by the operator. Then, the controller controls the clutch and the brake according to the turn command and thus generates a speed difference between the left and right drive wheels. Thus, the vehicle body turns.

### SUMMARY

For example, when the work machine makes a small turn to change the direction or makes a small turn during work, the operator inputs a large turn command. At this time, when the load on the vehicle body is large, the vehicle body cannot turn, and the outer crawler belt may severely slip. If such a slip state continues, the vehicle body is worn and a loss of the driving force occurs. An object of the present disclosure is to cause a work machine to quickly escape from the slip state.

A system according to a first aspect of the present disclosure is a system for controlling a work machine. The work machine includes a vehicle body, a left drive wheel, a right drive wheel, a drive source, a drive device, a yaw angle sensor, and a controller. The left drive wheel is rotatably supported to the vehicle body. The right drive wheel is rotatably supported to the vehicle body. The drive source is installed in the vehicle body. The drive device rotates the left drive wheel and the right drive wheel by the driving force from the drive source. The yaw angle sensor detects an actual yaw angular velocity of the vehicle body.

The controller controls the drive device to turn the vehicle body by a rotational speed difference between the left drive wheel and the right drive wheel. The controller calculates a theoretical yaw angular velocity of the vehicle body corresponding to control of the drive device. The controller acquires the actual yaw angular velocity. The controller calculates an actual slip value indicating the magnitude of a slip of the vehicle body during turning, based on the theoretical yaw angular velocity and the actual yaw angular velocity. The controller controls the rotational speed of at least one of the left drive wheel and the right drive wheel such that the actual slip value reaches a predetermined target slip value higher than 0.

In the system according to the present aspect, when the actual slip value is higher than the predetermined target slip value, the rotational speed of at least one of the left drive wheel and the right drive wheel is controlled such that the actual slip value reaches the predetermined target slip value. This allows the work machine to quickly escape from the slip state.

Also, in an environment where the work machine is used, the work machine slightly slips even in a normal state. Therefore, even when the work machine is in the normal state, the slip ratio is not 0. In the system according to the present aspect, the rotational speed of at least one of the left drive wheel and the right drive wheel is controlled such that the actual slip value reaches the predetermined target slip value higher than 0. Thus, an excessive reduction in the actual slip value is suppressed.

A method according to a second aspect of the present disclosure is a method for controlling a work machine. The work machine includes a vehicle body, a left drive wheel, a right drive wheel, a drive source, and a drive device. The left drive wheel is rotatably supported to the vehicle body. The right drive wheel is rotatably supported to the vehicle body. The drive source is installed in the vehicle body. The drive device rotates the left drive wheel and the right drive wheel by the driving force from the drive source.

The method includes controlling the drive device to turn the vehicle body by a rotational speed difference between the left drive wheel and the right drive wheel, calculating a theoretical yaw angular velocity of the vehicle body corresponding to control of the drive device, acquiring an actual yaw angular velocity of the vehicle body, calculating an actual slip value of the vehicle body during turning, based on the theoretical yaw angular velocity and the actual yaw angular velocity, and controlling a rotational speed of at least one of the left drive wheel and the right drive wheel such that the actual slip value reaches a predetermined target slip value higher than 0.

In the method according to the present aspect, the work machine can quickly escape from the slip state. Also, an excessive reduction in the actual slip value is suppressed.

A method according to a third aspect of the present disclosure is a method for controlling a work machine. The work machine includes a vehicle body, a left drive wheel, a right drive wheel, a drive source, and a drive device. The left drive wheel is rotatably supported to the vehicle body. The right drive wheel is rotatably supported to the vehicle body. The drive source is installed in the vehicle body. The drive device rotates the left drive wheel and the right drive wheel by the driving force from the drive source.

The method includes controlling the drive device to turn the vehicle body by a rotational speed difference between the left drive wheel and the right drive wheel, acquiring a rotational speed of the left drive wheel, acquiring a rotational speed of the right drive wheel, calculating a theoretical yaw angular velocity of the vehicle body, based on the rotational speed of the left drive wheel and the rotational speed of the right drive wheel, acquiring an actual yaw angular velocity of the vehicle body, calculating an actual slip value of the vehicle body during turning, based on the theoretical yaw angular velocity and the actual yaw angular velocity, and controlling the rotational speed of at least one of the left drive wheel and the right drive wheel to reduce the actual slip value when the actual slip value is higher than a predetermined target slip value.

In the method according to the present aspect, when the actual slip value is higher than the predetermined target slip value, the rotational speed of at least one of the left drive wheel and the right drive wheel is controlled so as to reduce the actual slip value. This allows the work machine to quickly escape from the slip state. The theoretical yaw angular velocity of the vehicle body is calculated, based on the rotational speed of the left drive wheel and the rotational speed of the right drive wheel. Therefore, for example, compared with when the theoretical yaw angular velocity is calculated based on the amount of operation of the operation lever of the drive wheel, the theoretical yaw angular velocity is calculated with high accuracy.

According to the present disclosure, a work machine can be made to quickly escape from a slip state.

### BRIEF DESCRIPTION OF DRAWINGS

FIG. 1 is a perspective view of a work machine according to an embodiment.

FIG. 2 is a top view of the work machine.

FIG. 3 is a schematic diagram illustrating the configuration of the work machine.

FIG. 4 is a block diagram illustrating processing of slip control.

FIG. 5 is a schematic diagram showing the configuration of a work machine according to a first modification example.

FIG. 6 is a schematic diagram showing the configuration of a work machine according to a second modification example.

FIG. 7 is a schematic diagram showing the configuration of a work machine according to a third modification example.

FIG. 8 is a schematic diagram showing the configuration of a work machine according to a fourth modification example.

FIG. 9 is a schematic diagram showing the configuration of a work machine according to a fifth modification example.

### DETAILED DESCRIPTION OF EMBODIMENT(S)

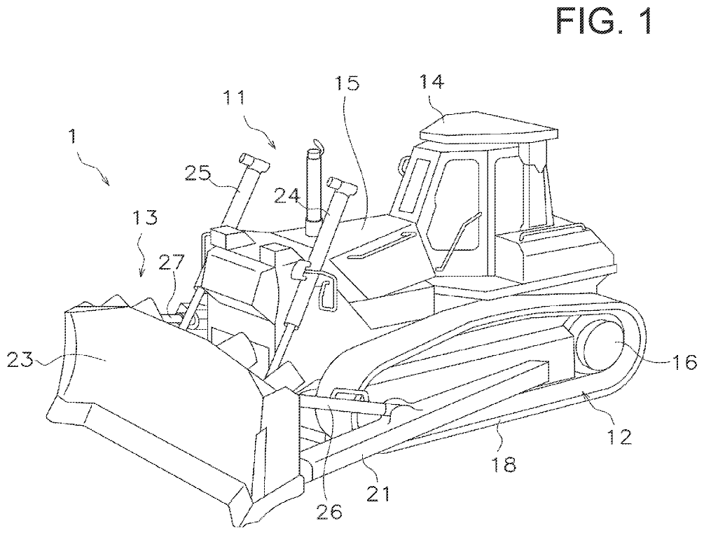

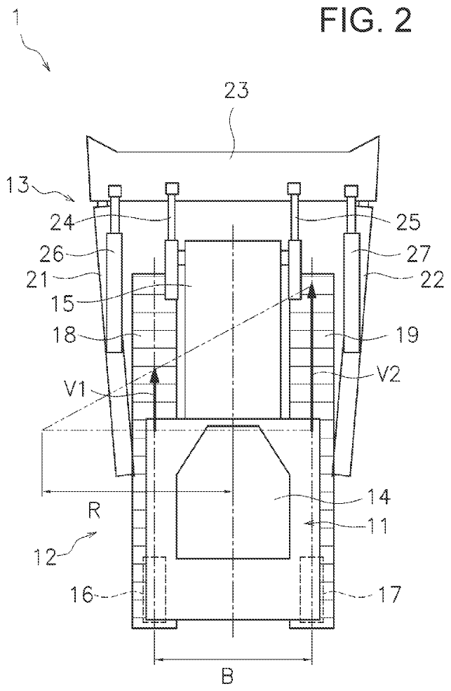

Hereinafter, a control system and a control method for a work machine according to an embodiment will be described with reference to the drawings. FIG. 1 is a side view illustrating a work machine 1 according to the embodiment. FIG. 2 is a top view of the work machine 1. The work machine 1 according to the present embodiment is a bulldozer. The work machine 1 includes a vehicle body 11, a traveling device 12, and a work implement 13. The vehicle body 11 includes a cab 14 and a power chamber 15. An operator's seat, not shown, is disposed in the cab 14. The power chamber 15 is disposed in front of the cab 14.

The traveling device 12 is attached to a lower portion of the vehicle body 11. The traveling device 12 includes a left drive wheel 16, a right drive wheel 17, a left crawler belt 18, and a right crawler belt 19. The left drive wheel 16 and the right drive wheel 17 are rotatably supported to the vehicle body 11. The left crawler belt 18 is wound around the left drive wheel 16. The right crawler belt 19 is wound around the right drive wheel 17. When the left and right drive wheels 16, 17 rotate and the left and right crawler belts 18, 19 are driven, the work machine 1 travels.

The work implement 13 is attached to the vehicle body 11. The work implement 13 includes lift frames 21, 22, a blade 23, lift cylinders 24, 25, and tilt cylinders 26, 27. The lift frames 21, 22 are attached to the vehicle body 11 so as to be movable up and down. The lift frames 21, 22 support the blade 23.

The blade 23 is disposed in front of the vehicle body 11. The blade 23 moves up and down as the lift frames 21, 22 move up and down. The lift cylinders 24, 25 are coupled to the vehicle body 11 and the blade 23. Alternatively, the lift cylinders 24, 25 may be coupled to the vehicle body 11 and the lift frames 21, 22. As the lift cylinders 24, 25 expand and contract, the lift frames 21, 22 move up and down. The tilt cylinders 26, 27 are coupled to the lift frames 21, 22 and the blade 23. When the tilt cylinders 26, 27 expand and contract, the left and right ends of the blade 23 tilt up and down.

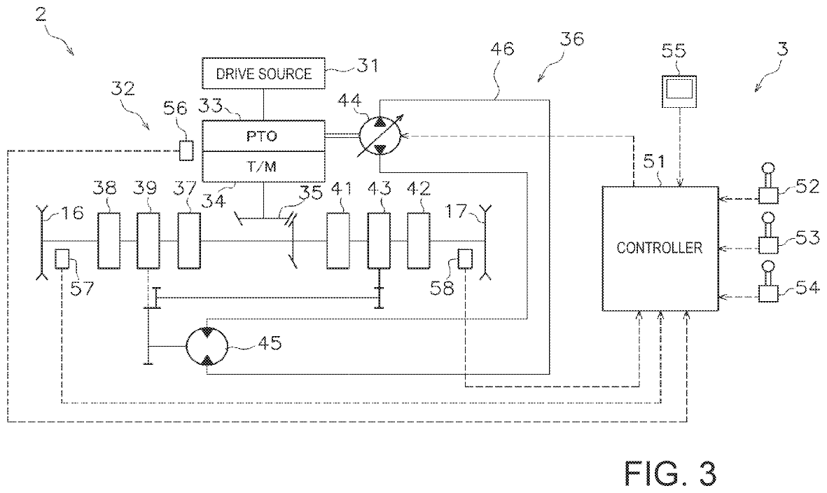

FIG. 3 is a block diagram illustrating the configuration of a drive system 2 and a control system 3 of the work machine 1. As shown in FIG. 3, the drive system 2 includes a drive source 31 and a drive device 32. The drive source 31 and the drive device 32 are installed in the vehicle body 11. The drive source 31 includes, for example, an internal combustion engine. The drive device 32 rotates the left drive wheel 16 and the right drive wheel 17 by the driving force from the drive source 31. The drive system 2 includes a hydraulic pump (not shown) for the work implement 13. The hydraulic pump for the work implement 13 is driven by the drive source 31 and discharges hydraulic oil for driving the above-described cylinders 24 to 27.

The drive device 32 includes a PTO (power take-off) 33, a transmission 34, a transfer case 35, and a steering mechanism 36. The PTO 33 distributes the driving force from the drive source 31 to the transmission 34 and the steering mechanism 36. The transmission 34 is coupled to the drive source 31 via the PTO 33. The transmission 34 includes, for example, a clutch and a plurality of transmission gears. The transmission 34 is coupled to the left drive wheel 16 and the right drive wheel 17 via the transfer case 35.

The drive device 32 includes a left clutch 37, a left brake 38, and a left link mechanism 39. The left clutch 37, the left brake 38, and the left link mechanism 39 are coupled to the left drive wheel 16. The left clutch 37 switches between transmission and interruption of the driving force from the transmission 34 to the left drive wheel 16. The left brake 38 brakes the left drive wheel 16. The left link mechanism 39 couples the left drive wheel 16 and the steering mechanism 36. The left link mechanism 39 includes, for example, a planetary gear mechanism.

The drive device 32 includes a right clutch 41, a right brake 42, and a right link mechanism 43. The right clutch 41, the right brake 42, and the right link mechanism 43 are coupled to the right drive wheel 17. The right clutch 41 switches between transmission and interruption of the driving force from the transmission 34 to the right drive wheel 17. The right brake 42 brakes the right drive wheel 17. The right link mechanism 43 couples the right drive wheel 17 and the steering mechanism 36. The right link mechanism 43 includes, for example, a planetary gear mechanism.

The steering mechanism 36 generates a rotational speed difference between the left drive wheel 16 and the right drive wheel 17 and thus causes the vehicle body 11 to turn. For example, the steering mechanism 36 increases the speed of the left drive wheel 16 to be higher than that of the right drive wheel 17 and thus causes the vehicle body 11 to turn rightward. The steering mechanism 36 increases the speed of the right drive wheel 17 to be higher than that of the left drive wheel 16 and thus causes the vehicle body 11 to turn leftward. The steering mechanism 36 includes a hydraulic pump 44 and a hydraulic motor 45.

The hydraulic pump 44 is coupled to the drive source 31 via the PTO 33. The hydraulic pump 44 is driven by the drive source 31 to discharge hydraulic oil. The hydraulic motor 45 is coupled to the hydraulic pump 44 via a hydraulic circuit 46. The hydraulic motor 45 is driven by the hydraulic oil discharged from the hydraulic pump 44. The hydraulic motor 45 is coupled to the left drive wheel 16 via the left link mechanism 39. The hydraulic motor 45 is coupled to the right drive wheel 17 via the right link mechanism 43. The hydraulic motor 45 is driven by the hydraulic oil from the hydraulic pump 44 to increase the speeds of the left drive wheel 16 and the right drive wheel 17.

The control system 3 includes a controller 51. The controller 51 is programmed to control the work machine 1. The controller 51 includes memories such as a RAM and a ROM, and a processor such as a CPU. The controller 51 may include an auxiliary storage device such as an SSD or an HDD. The controller 51 records a program and data for controlling the work machine 1. The controller 51 executes processing for controlling the work machine 1, based on the program and the data. The control system 3 includes a speed change operation member 52, a work implement operation member 53, a steering operation member 54, and an input device 55. The speed change operation member 52 can be operated by the operator to switch the speed reduction ratio of the transmission 34. The speed change operation member 52 is, for example, a lever, but may be another member such as a switch. The controller 51 controls the transmission 34 according to the operation of the speed change operation member 52. The work implement operation member 53 can be operated by the operator to operate the work implement 13. The work implement operation member 53 is, for example, a lever, but may be another member such as a switch. The controller 51 controls the work implement 13 according to the operation of the work implement operation member 53.

The steering operation member 54 can be operated by the operator to turn the vehicle body 11 to the left or right. The steering operation member 54 is, for example, a lever, but may be another member such as a switch. The controller 51 controls the steering mechanism 36 according to the operation of the steering operation member 54. The input device 55 can be operated by the operator to configure settings for the work machine 1. The input device 55 is, for example, a touch screen, but may be another member such as a switch.

The control system 3 includes a yaw angle sensor 56, a first speed sensor 57, and a second speed sensor 58. The yaw angle sensor 56 detects an actual yaw angular velocity of the vehicle body 11. The actual yaw angular velocity of the vehicle body 11 indicates the amount of change per unit time in the yaw angle of the vehicle body 11. The yaw angle sensor 56 is, for example, an inertial measurement unit (IMU). Alternatively, the yaw angle sensor 56 may be a position sensor such as a global positioning system (GPS). Alternatively, the yaw angle sensor 56 may be another sensor such as an orientation angle sensor or a yaw rate sensor. The yaw angle sensor 56 outputs a signal indicating the actual yaw angular velocity of the vehicle body 11 to the controller 51. Alternatively, the yaw angle sensor 56 may output a signal indicating the actual yaw angle of the vehicle body 11 to the controller 51, and the controller 51 may calculate the actual yaw angular velocity from a change in the actual yaw angle.

The first speed sensor 57 and the second speed sensor 58 are rotation sensors. The first speed sensor 57 detects an actual rotational speed of the left drive wheel 16. The first speed sensor 57 outputs a signal indicating the rotational speed of the left drive wheel 16 to the controller 51. The second speed sensor 58 detects an actual rotational speed of the right drive wheel 17. The second speed sensor 58 outputs a signal indicating the rotational speed of the right drive wheel 17 to the controller 51.

As described above, the controller 51 controls the steering mechanism 36 according to the operation of the steering operation member 54. Thus, the vehicle body 11 turns according to the operation of the steering operation member 54. Specifically, the controller 51 acquires an amount of operation (hereinafter referred to as an amount of steering operation) and an operation direction of the steering operation member 54. The controller 51 controls the displacement of the hydraulic pump 44 according to the amount of steering operation. Thus, the magnitude of speed increase of the left drive wheel 16 or the right drive wheel 17 is controlled.

The controller 51 controls the left link mechanism 39 and the right link mechanism 43 according to the operation direction of the steering operation member 54 and thus increases the speed of one of the left drive wheel 16 and the right drive wheel 17. For example, when the operation direction of the steering operation member 54 is a left turn, the hydraulic motor 45 increases the speed of the right drive wheel 17 via the right link mechanism 43. Accordingly, the rotational speed of the right drive wheel 17 becomes higher than the rotational speed of the left drive wheel 16, and the vehicle body 11 turns to the left due to the rotational speed difference. When the operation direction of the steering operation member 54 is a right turn, the hydraulic motor 45 increases the speed of the left drive wheel 16 via the left link mechanism 39. Accordingly, the rotational speed of the left drive wheel 16 becomes higher than the rotational speed of the right drive wheel 17, and the vehicle body 11 turns to the right due to the rotational speed difference.

As described above, when the operator operates the steering operation member 54 to turn the vehicle body 11, the vehicle body 11 may not be able to turn and the outer crawler belt may severely slip. In the control system 3 of the work machine 1 according to the present embodiment, when the vehicle body 11 falls into a slip state during turning, the controller 51 executes slip control to cause the vehicle body 11 to quickly escape from the slip state. Hereinafter, the processing of the slip control will be described.

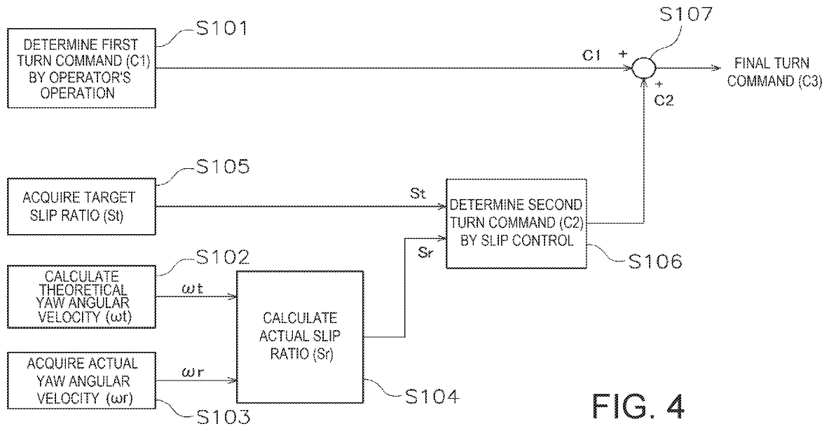

FIG. 4 is a block diagram illustrating the processing of the slip control. As shown in FIG. 4, in step S101, the controller 51 determines a first turn command C1 based on the operation by the operator. The controller 51 determines the first turn command C1 according to the above-described amount of steering operation. The first turn command C1 indicates the magnitude of speed increase of the left crawler belt 18 or the right crawler belt 19 according to the amount of steering operation.

Specifically, the first turn command C1 is given as a command value to the hydraulic pump 44. For example, the controller 51 stores turn command data that defines the relationship between the amount of steering operation and the first turn command C1. The controller 51 determines the first turn command C1 from the amount of steering operation with reference to the turn command data.

In step S102, the controller 51 acquires a theoretical yaw angular velocity ωt. The theoretical yaw angular velocity ωt is the yaw angular velocity of the vehicle body 11 during turning calculated in accordance with control of the drive device 32. Specifically, the theoretical yaw angular velocity ωt is the yaw angular velocity of the vehicle body 11 calculated from the operating speed of the left crawler belt 18 and the operating speed of the right crawler belt 19. The theoretical yaw angular velocity ωt is expressed by the following equation (1).

$$ω t = \frac{V 2 + V 1}{2 R} \qquad ( 1 )$$

V1 is the operating speed (hereinafter referred to as an inner speed) of the crawler belt positioned on the inner side of the turning (hereinafter referred to as an inner crawler belt), of the left crawler belt 18 and the right crawler belt 19. V2 is the operating speed (hereinafter referred to as an outer speed) of the crawler belt positioned on the outer side of the turning (hereinafter referred to as an outer crawler belt), of the left crawler belt 18 and the right crawler belt 19. When the vehicle body 11 turns to the left, the inner speed V1 is the operating speed of the left crawler belt 18, and the outer speed V2 is the operating speed of the right crawler belt 19, as shown in FIG. 2. Conversely, when the vehicle body 11 turns to the right, the inside speed V1 is the operating speed of the right crawler belt 19, and the outside speed V2 is the operating speed of the left crawler belt 18.

The controller 51 calculates the operating speed of the left crawler belt 18, based on the rotational speed of the left drive wheel 16 and the speed reduction ratio of the drive device 32. The controller 51 calculates the operating speed of the right crawler belt 19, based on the rotational speed of the right drive wheel 17 and the speed reduction ratio of the drive device 32. In the equation (1), R is the turning radius. The turning radius R is expressed by the following equation (2).

$$R = \frac{B}{2} \cdot \frac{( V 2 + V 1 )}{( V 2 - V 1 )} \qquad ( 2 )$$

B is the gauge width. As shown in FIG. 2, the gauge width B is a center-to-center distance between the left crawler belt 18 and the right crawler belt 19. The gauge width is a value unique to the model of the work machine 1 and is stored in the controller 51. From the equations (1) and (2), the theoretical yaw angular velocity ωt is expressed by the following equation (3). The controller 51 calculates the theoretical yaw angular velocity ωt by the equation (3), based on the inner speed V1 and the outer speed V2.

$$ω t = \frac{( V 2 - V 1 )}{2} \cdot \frac{1000}{3600} \cdot \frac{2}{B} \cdot \frac{180}{π} \qquad ( 3 )$$

In step S103, the controller 51 acquires an actual yaw angular velocity ωr. The actual yaw angular velocity ωr is the actual yaw angular velocity of the vehicle body 11. The controller 51 acquires the current actual yaw angular velocity ωr from a signal from the yaw angle sensor 56.

In step S104, the controller 51 calculates an actual slip ratio Sr. The actual slip ratio Sr indicates the magnitude of the slip of the vehicle body 11. The controller 51 calculates the actual slip ratio Sr of the vehicle body 11 during turning, based on the theoretical yaw angular velocity ωt and the actual yaw angular velocity ωr. The controller 51 calculates the actual slip ratio Sr of the vehicle body 11 by the following equation (4).

$$Sr = \frac{( ω t - ω r )}{ω t} \cdot 100 \qquad ( 4 )$$

In step S105, the controller 51 acquires a target slip ratio St. The target slip ratio St is a predetermined value higher than 0. The target slip ratio St may be a fixed value stored in the controller 51. The target slip ratio St is set to be, for example, a value such that the operator feels that the vehicle body 11 is in the normal state instead of the slip state, where turning is difficult. However, the target slip ratio St may be variable.

In step S106, the controller 51 determines a second turn command C2 by the slip control. The controller 51 determines the second turn command C2 by the slip control such that the actual slip ratio Sr reaches the target slip ratio St. The controller 51 determines the second turn command C2 by the slip control, by P (proportional) control using, for example, the following equation (5). In the following equation (5), Kp is the P gain.

C2=Kp·(St−Sr) (5)

In step S107, the controller 51 determines a final turn command C3. The controller 51 determines the final turn command C3 by adding the second turn command C2 by the slip control to the first turn command C1 by the operator's operation. The controller 51 controls the hydraulic pump 44 by the final turn command C3.

For example, when the actual slip ratio Sr is higher than the target slip ratio St, the second turn command C2 by the slip control has a negative value. Therefore, the controller 51 reduces the final turn command C3 to be lower than the first turn command C1 by the operator's operation. Thus, the operating speed of the outer crawler belt during turning is reduced. As a result, the actual slip ratio Sr decreases, and the vehicle body 11 can escape from the slip state.

As the vehicle body 11 escapes from the slip state, the actual slip ratio Sr decreases and approaches the target slip ratio St. When the actual slip ratio Sr decreases and the difference between the actual slip ratio Sr and the target slip ratio St decreases, the controller 51 decreases the value of the turn command C2. Then, the controller 51 increases the final turn command C3 so as to approach the first turn command C1 by the operator's operation. Thus, the operating speed of the outer crawler belt during turning increases. As a result, work efficiency is improved.

The control system 3 of the work machine 1 according to the present embodiment described above controls the rotational speed of at least one of the left drive wheel 16 and the right drive wheel 17 such that the actual slip ratio Sr reaches the target slip ratio St. This allows the work machine 1 to quickly escape from the slip state.

The target slip ratio St is a predetermined value higher than 0. Therefore, an excessive reduction in the actual slip ratio Sr is suppressed. Thus, work efficiency is improved.

The theoretical yaw angular velocity ωt of the vehicle body 11 is calculated, based on the actual rotational velocity of the left drive wheel 16 and the actual rotational velocity of the right drive wheel 17. Therefore, the theoretical yaw angular velocity ωt of the vehicle body 11 is accurately calculated.

Although one embodiment of the present invention has been described above, the present invention is not limited to the above-described embodiment, and various modifications can be made without departing from the spirit and scope of the invention.

The work machine 1 is not limited to a bulldozer and may be another machine such as a shovel, a wheel loader, or a tractor. The traveling device 12 is not limited to a crawler belt and may include a tire. The work machine 1 may be a vehicle that can be remotely operated. In this case, the operation members 52 to 54 and the input device 55 may be disposed outside the work machine 1. The cab 14 may be omitted from the work machine 1.

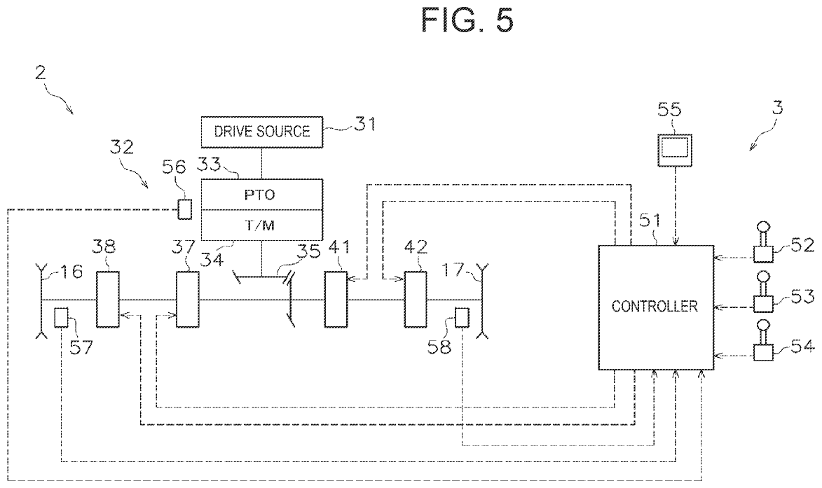

The configuration of the drive device 32 is not limited to that of the above embodiment and may be changed. For example, the clutches 37, 41 may be omitted from the work machine 1 according to the above embodiment. Alternatively, FIG. 5 is a schematic diagram showing the configuration of the work machine 1 according to a first modification example. As shown in FIG. 5, the steering mechanism 36 and the link mechanisms 39, 43 may be omitted from the drive device 32. The controller 51 may control the clutches 37, 41 and the brakes 38, 42 to generate a rotational speed difference between the left drive wheel 16 and the right drive wheel 17 and thereby cause the vehicle body 11 to turn.

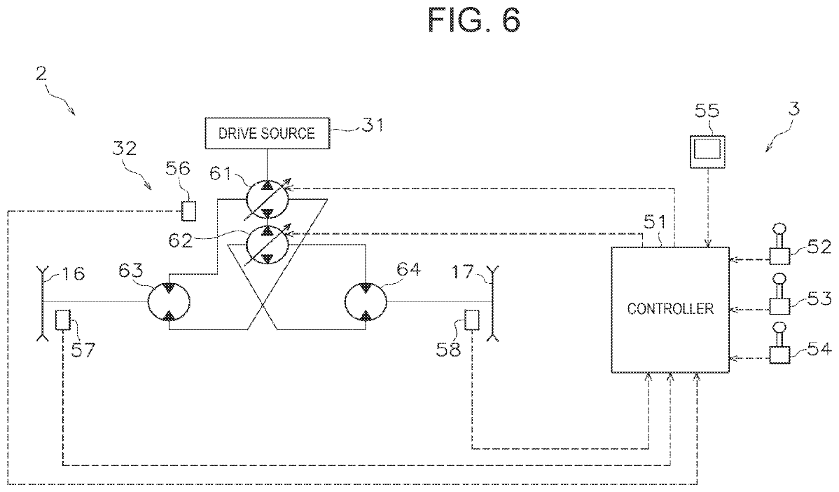

FIG. 6 is a schematic diagram illustrating the configuration of the work machine 1 according to a second modification example. As shown in FIG. 6, the drive device 32 may include a first travel pump 61, a second travel pump 62, a first travel motor 63, and a second travel motor 64. The first travel pump 61 and the second travel pump 62 are hydraulic pumps. The first travel pump 61 and the second travel pump 62 are driven by the drive source 31. The first travel motor 63 and the second travel motor 64 are hydraulic motors. The first travel motor 63 is driven by the hydraulic oil from the first travel pump 61. The first travel motor 63 is coupled to the left drive wheel 16 and rotates the left drive wheel 16. The second travel motor 64 is driven by the hydraulic oil from the second travel pump 62. The second travel motor 64 is coupled to the right drive wheel 17 and rotates the right drive wheel 17. The controller 51 may control the displacement of the first travel pump 61 and the displacement of the second travel pump 62 to generate a rotational speed difference between the left drive wheel 16 and the right drive wheel 17 and thus cause the vehicle body 11 to turn.

The slip control is not limited to that in the above embodiment and may be changed. For example, the actual slip ratio Sr is an example of the actual slip value. Instead of the actual slip ratio Sr, the actual amount of slip may be used as the actual slip value. The actual amount of slip may be indicated by the difference between the theoretical yaw angular velocity ωt and the actual yaw angular velocity ωr. Similarly, the target slip ratio St is an example of the target slip value. Instead of the target slip ratio St, a target amount of slip may be used as the target slip value.

The method for determining the target slip ratio St is not limited to that in the above embodiment and may be changed. For example, the target slip ratio St may be able to be set by the input device 55. The operator may be able to input the value of the target slip ratio St, using the input device 55. Alternatively, the target slip ratio St may be set according to selection of a level indicating the strength of the slip control such as “strong”, “medium”, and “weak”.

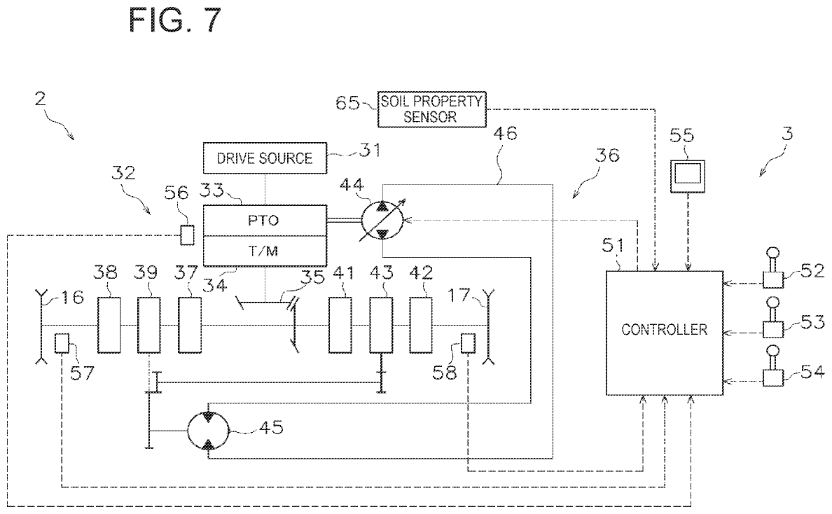

Alternatively, FIG. 7 is a schematic diagram illustrating the configuration of the work machine 1 according to a third modification example. As shown in FIG. 7, the work machine 1 may include a soil property sensor 65. The soil property sensor 65 detects the hardness of the ground on which the work machine 1 is disposed. The controller 51 may acquire the hardness of the ground on which the work machine 1 is disposed, and determine the predetermined target slip ratio St, based on the hardness of the ground. For example, the controller 51 may increase the predetermined target slip ratio St as the hardness of the ground becomes softer.

Alternatively, the controller 51 may acquire the hardness of the ground, based on work site information. The work site information indicates the relationship between the position in the work site where the work machine 1 is disposed and the hardness of the ground. The controller 51 may receive the selection of any position in the work site via the input device 55. For example, the input device 55 may include a monitor, and a map of the work site may be displayed on the monitor. The operator may select any position from the map displayed on the monitor. The controller 51 may acquire the hardness of the ground corresponding to the selected position in the work site with reference to the work site information.

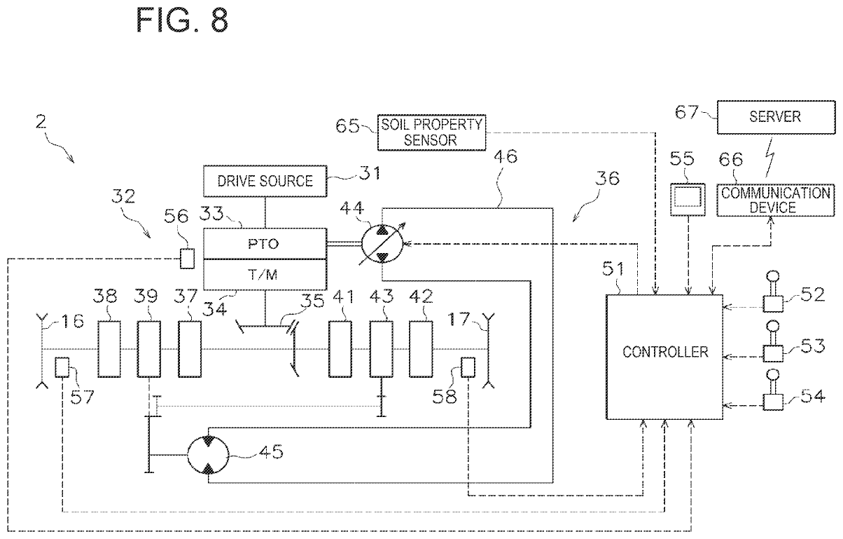

The predetermined target slip ratio St may be determined not only by the controller 51 of the work machine 1 but also by a computer outside the work machine 1. The controller 51 may acquire the target slip ratio St from the external computer. For example, FIG. 8 is a schematic diagram illustrating the configuration of the work machine 1 according to a fourth modification example.

As shown in FIG. 8, the work machine 1 may include a communication device 66. The communication device 66 is, for example, a module for wireless communication, and communicates with a computer outside the work machine 1. The communication device 66 may use a mobile communication network. Alternatively, the communication device 66 may use another network such as a local area network (LAN) or the Internet. The work machine 1 may transmit the acquired hardness of the ground to an external server 67 via the communication device 66. The server 67 may calculate the target slip ratio St according to the hardness of the ground and transmit the target slip ratio St to the controller 51 of the work machine 1 via the communication device 66.

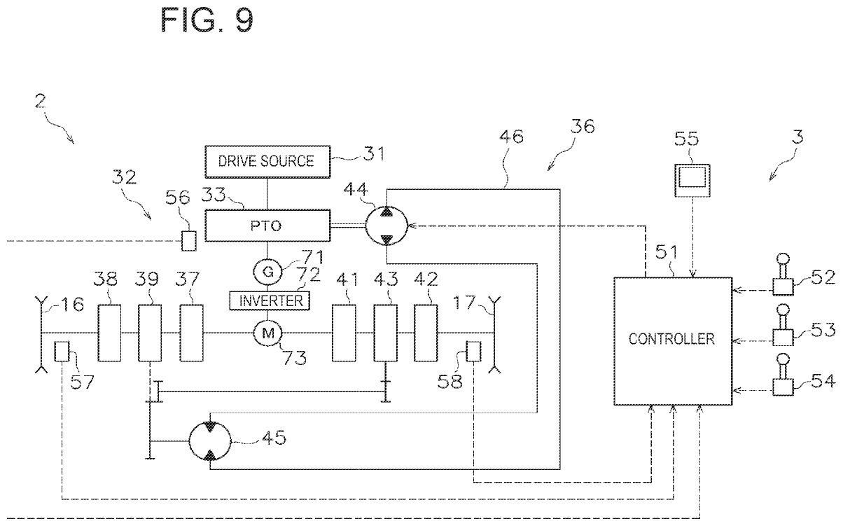

In the above-described embodiment or modifications examples, the drive source 31 is not limited to an internal combustion engine and may include an electric motor. The electric motor may be driven by electric power generated by the driving force of the internal combustion engine. For example, as in a fifth modification example shown in FIG. 9, the work machine 1 may include a generator 71 and a motor 73 instead of the transmission 34. The generator 71 may generate electric power by the driving force from the drive source 31. The motor 73 may be coupled to the generator 71 via an inverter 72. The motor 73 may be driven by electric power generated by the generator 71 and thus drive the drive wheels 16, 17. Similarly, in the other modification examples described above, the work machine 1 may include a generator and a motor instead of the transmission 34. Alternatively, the work machine 1 may include a generator and a motor instead of the travel pumps 61, 62 and the travel motors 63, 64.

According to the present disclosure, a work machine can be made to quickly escape from a slip state.

1. A system for controlling a work machine including a vehicle body, a left drive wheel rotatably supported to the vehicle body, a right drive wheel rotatably supported to the vehicle body, a drive source installed in the vehicle body, and a drive device that rotates the left drive wheel and the right drive wheel by a driving force from the drive source, the system comprising:
a yaw angle sensor that detects an actual yaw angular velocity of the vehicle body; and
a controller that controls the drive device to turn the vehicle body by a rotational speed difference between the left drive wheel and the right drive wheel, the controller
calculating a theoretical yaw angular velocity of the vehicle body according to control of the drive device,
acquiring the actual yaw angular velocity,
calculating an actual slip value indicating a magnitude of a slip of the vehicle body during turning, based on the theoretical yaw angular velocity and the actual yaw angular velocity, and
controlling a rotational speed of at least one of the left drive wheel and the right drive wheel such that the actual slip value reaches a predetermined target slip value higher than 0.

2. The system according to claim 1, wherein
when the actual slip value is higher than the target slip value, the controller reduces the rotational speed of a drive wheel located on an outer side during turning, of the left drive wheel and the right drive wheel.

3. The system according to claim 2, wherein
the controller increases the rotational speed of the drive wheel located on the outer side during turning, of the left drive wheel and the right drive wheel, in accordance with a decrease in the actual slip value.

4. The system according to claim 1, further comprising:
a first speed sensor that detects the rotational speed of the left drive wheel; and
a second speed sensor that detects the rotational speed of the right drive wheel,
the controller calculating the theoretical yaw angular velocity, based on the rotational speed of the left drive wheel and the rotational speed of the right drive wheel.

5. The system according to claim 4, further comprising:
a left crawler belt wound around the left drive wheel; and
a right crawler belt wound around the right drive wheel,
the controller
calculating an operating speed of the left crawler belt, based on the rotational speed of the left drive wheel,
calculating an operating speed of the right crawler belt, based on the rotational speed of the right drive wheel, and
calculating the theoretical yaw angular velocity, based on the operating speed of the left crawler belt and the operating speed of the right crawler belt.

6. The system according to claim 1, wherein the predetermined target slip value is a fixed value.

7. The system according to claim 1, further comprising:
an input device that can be operated by an operator,
the predetermined target slip value being set by the input device.

8. The system according to claim 1, wherein
the controller
acquires a hardness of a ground on which the work machine is disposed, and
determines the predetermined target slip value, based on the hardness of the ground.

9. The system according to claim 1, wherein
the controller
acquires work site information indicating a relationship between a position in a work site where the work machine is disposed and a hardness of a ground,
receives selection of any position in the work site,
acquires the hardness of the ground corresponding to the selected position in the work site with reference to the work site information, and
determines the predetermined target slip value, based on the hardness of the ground.

10. A method for controlling a work machine including a vehicle body, a left drive wheel rotatably supported to the vehicle body, a right drive wheel rotatably supported to the vehicle body, a drive source installed in the vehicle body, and a drive device that rotates the left drive wheel and the right drive wheel by a driving force from the drive source, the method comprising:
controlling the drive device to turn the vehicle body by a rotational speed difference between the left drive wheel and the right drive wheel;
calculating a theoretical yaw angular velocity of the vehicle body according to control of the drive device;
acquiring an actual yaw angular velocity of the vehicle body;
calculating an actual slip value indicating a magnitude of a slip of the vehicle body during turning, based on the theoretical yaw angular velocity and the actual yaw angular velocity; and
controlling a rotational speed of at least one of the left drive wheel and the right drive wheel such that the actual slip value reaches a predetermined target slip value higher than 0.

11. The method according to claim 10, further comprising:
reducing the rotational speed of a drive wheel located on an outer side during turning, of the left drive wheel and the right drive wheel, when the actual slip value is higher than the target slip value.

12. The method according to claim 11, further comprising:
increasing the rotational speed of the drive wheel located on the outer side during turning, of the left drive wheel and the right drive wheel, in accordance with a decrease in the actual slip value.

13. The method according to claim 10, further comprising:
acquiring the rotational speed of the left drive wheel;
acquiring the rotational speed of the right drive wheel; and
calculating the theoretical yaw angular velocity, based on the rotational speed of the left drive wheel and the rotational speed of the right drive wheel.

14. The method according to claim 13, wherein
the work machine further includes
a left crawler belt wound around the left drive wheel, and
a right crawler belt wound around the right drive wheel, and
the method further comprises:
calculating an operating speed of the left crawler belt, based on the rotational speed of the left drive wheel;
calculating an operating speed of the right crawler belt, based on the rotational speed of the right drive wheel; and
calculating the theoretical yaw angular velocity, based on the operating speed of the left crawler belt and the operating speed of the right crawler belt.

15. The method according to claim 10, wherein
the predetermined target slip value is a fixed value.

16. The method according to claim 10, wherein
the predetermined target slip value is set by an input device that can be operated by an operator.

17. The method according to claim 10, further comprising:
acquiring a hardness of a ground on which the work machine is disposed; and
determining the predetermined target slip value, based on the hardness of the ground.

18. The method according to claim 10, further comprising:
acquiring work site information indicating a relationship between a position in a work site where the work machine is disposed and a hardness of a ground;
receiving selection of any position in the work site;
acquiring the hardness of the ground corresponding to the selected position in the work site with reference to the work site information; and
determining the predetermined target slip value, based on the hardness of the ground.

19. A method for controlling a work machine including a vehicle body, a left drive wheel rotatably supported to the vehicle body, a right drive wheel rotatably supported to the vehicle body, a drive source installed in the vehicle body, and a drive device that rotates the left drive wheel and the right drive wheel by a driving force from the drive source, the method comprising:
controlling the drive device to turn the vehicle body by a rotational speed difference between the left drive wheel and the right drive wheel;
acquiring a rotational speed of the left drive wheel;
acquiring a rotational speed of the right drive wheel;
calculating a theoretical yaw angular velocity of the vehicle body, based on the rotational speed of the left drive wheel and the rotational speed of the right drive wheel;
acquiring an actual yaw angular velocity of the vehicle body;
calculating an actual slip value of the vehicle body during turning, based on the theoretical yaw angular velocity and the actual yaw angular velocity; and
controlling the rotational speed of at least one of the left drive wheel and the right drive wheel so as to reduce the actual slip value when the actual slip value is higher than a predetermined target slip value.

20. The method according to claim 19, wherein
the work machine further includes
a left crawler belt wound around the left drive wheel, and
a right crawler belt wound around the right drive wheel, and
the method further comprises:
calculating an operating speed of the left crawler belt, based on the rotational speed of the left drive wheel;
calculating an operating speed of the right crawler belt, based on the rotational speed of the right drive wheel; and
calculating the theoretical yaw angular velocity, based on the operating speed of the left crawler belt and the operating speed of the right crawler belt.
